(19) United States
(12) Patent Application Publication
(10) Pub. No.: US 2019/0066534 A1
(43) Pub. Date: Feb. 28, 2019

(54) SYSTEM AND METHOD FOR CONTAINER IDENTIFICATION AND RECIPE ALIGNMENT BASED ON VOLUME

(71) Applicant: Perfect Company, Inc., Vancouver, WA (US)

(72) Inventor: Michael Wayne Wallace, Vancouver, WA (US)

(21) Appl. No.: 15/693,302

(22) Filed: Aug. 31, 2017

(51) Int. Cl. G09B 19/00; G09B 5/02; A47J 43/04; G01G 19/00

(52) U.S. Cl. CPC G09B 19/0092; G09B 5/02; G06F 3/04847; G01G 19/00; A47J 43/04

(57) ABSTRACT

A system and method directed to generating, by a smart scale, the identification of containers based on a weight measurement of the containers on the smart scale. The identification can be based on maximum and/or minimum target container volumes for the container. The system can use the smart app to operate the scale and process the container identification. The smart app also can receive a recipe and generate a recipe volume. The smart app can then align the recipe with the container by comparing the recipe volume with the maximum and/or minimum target volumes available for the container and adjusting the recipe number of servings, volume or other measurement.

### BACKGROUND

Containers are used to combine ingredients in order to make a recipe. There are a variety of approaches for selecting a container. One approach is that a recipe can be accompanied by a recommendation for the use of a specific container, a certain type or size container, as well as categories of containers (such as blender containers). For another approach, a container can be associated with recipes for use in the container, or categories of recipes (such as, beverages, baking or smoothies) can be packaged or otherwise associated with a container. Another approach is for a user to estimate the volume of a container based on a visual inspection in order to estimate whether the container can accommodate the recipe to be prepared. However, use of a visual inspection can prove to be inadequate. Also, a user can change the number of servings for the recipe just prior to or during recipe preparation, making estimates difficult. The measurement and comparison of container and recipe volumes is limited with visual inspection. Therefore, there is a need for greater precision in identifying containers and determining their volumes in order to provide an improved basis for selecting containers in which recipes can be prepared.

In addition, a container with a volume capacity that is different than a default recipe volume can require a change to the number of servings. For example, where a container volume capacity is less than the default recipe volume, a change to the recipe number of servings, such as ½ of the number of servings, can be needed in order to prepare the recipe in the container. Therefore, there also is a need to provide more precise alignment between container and recipe volumes, including not only selecting containers but also adjusting recipe volumes (or other measurement) to fit within the selected containers.

### BRIEF DESCRIPTION OF THE DRAWINGS

FIG. 1 is an illustrative example of a system that shows a client-computing device, a container and a smart scale.

FIG. 2 is a schematic diagram of an illustrative computing environment showing components that communicate to enable various operations involving container identification and alignment with recipe volumes based on measurement by a smart scale.

FIG. 3A is an illustrative data structure showing the data flow among various data sets associated with container identification and alignment with recipe volumes.

FIG. 3B is a container information table.

FIGS. 4A-4B are flow diagrams showing processes for implementing the system.

FIGS. 5A-5G are schematic diagrams of an illustrative computing system usable to provide container identification and alignment with recipe volumes.

FIGS. 6A-6C are schematic diagrams of an illustrative computing system usable to provide adjustment in recipes based on the receipt of user selected recipe measurements.

While implementations are described herein, by way of example, those skilled in the art will recognize that the implementations are not limited to the examples or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims.

When appropriate, reference materials and characters are used to designate identical, corresponding, or similar components in different figures. The figures associated with this disclosure typically are not drawn with dimensional accuracy to scale, i.e., such drawings have been drafted with a focus on clarity of viewing and understanding rather than dimensional accuracy.

The headings used herein are for organizational purposes only and are not meant to be used to limit the scope of the description or the claims. As used throughout this application, the word “can” is used in a permissive sense (i.e., meaning having the potential to), rather than the mandatory sense (i.e., meaning must). Similarly, the words “include,” “including” and “includes” mean including, but not limited to. In addition, use of directional terms such as “upper,” “lower,” “above,” “underneath,” or similar are intended to describe the positions and/or orientations of various components of the invention relative to one another as shown in the various figures and are not intended to impose limitations on any position and/or orientation of any embodiment of the invention relative to any reference point external to the reference.

### DETAILED DESCRIPTION

Examples of the present disclosure are directed to, among other things, methods and systems for generating, by a smart scale, the identification of containers based on a weight measurement of the containers on the smart scale. The identification can include maximum and minimum target container volumes for the container. The maximum target can be less than the full capacity of the container to accommodate space for recipe ingredient interaction during recipe preparation. The minimum target can be directed to an amount of recipe ingredients which can be combined and/or efficiently blended in a container with a blade, or similar. A smart app can be used to operate the scale and process the container identification. The smart app also can receive a recipe and determine a recipe volume. The smart app can then align the recipe with the container by comparing the recipe volume with the maximum and/or minimum target volumes available for the container. The smart app also can provide a user interface to present data including the container identification, the maximum and minimum target container volumes (also referred to as the target container volume range) and the recipe volume. Where the recipe volume is less than the maximum target container volume, then the container and the recipe are aligned regarding the maximum target volume. Where the recipe volume is greater than the minimum target container volume, then the container and the recipe are aligned regarding the minimum target volume. The user interface can then present the relationship between the recipe volume relative to the maximum and/or minimum target container volumes. In addition, the smart app can assess whether the recipe initial (or default as initially presented in the recipe) number of servings is within the container range. Where it is not, one approach for processing by the smart app is to reduce the number of servings of the recipe in order to generate a recipe volume that is within the target container range. The smart app also can assess the container versus the recipe volumes based on one of either the maximum target container volume or the minimum target container volume, in contrast to identifying a recipe volume that is within the target container volume range. The smart app can then provide a process for combining the ingredients for a recipe in the detected container.

Alternative or additional recipe adjustments for alignment with container target volumes can be based on recipe characteristics. Recipes can be written to include predetermined amounts of ingredients and a serving size. A serving size is a quantity of a recipe that is predetermined for a single portion, based on standards promulgated by recognized industry institutions, such as the American Heart Association®, or similar. Serving sizes are generated to make it easier to compare similar foods. A serving size also can be used to calculate nutritional information, such as, an amount per serving. A default recipe serving size can equate to a default number of servings for the recipe of 1. In selecting or preparing recipes, a user can change the number of servings from the default quantity. For example, if the default number of servings is 1 and it is subsequently change to a number of servings of 3 or ½, the recipe includes 3 or ½, respectively, times a default serving size of 1. There are a number of factors that can be considered to select the number of servings for recipes. For example, one factor can be the number of people for whom a recipe is prepared. Another factor can be to align the recipe volume with the container target volumes. Another factor can be the size of the container in which the recipe is prepared.

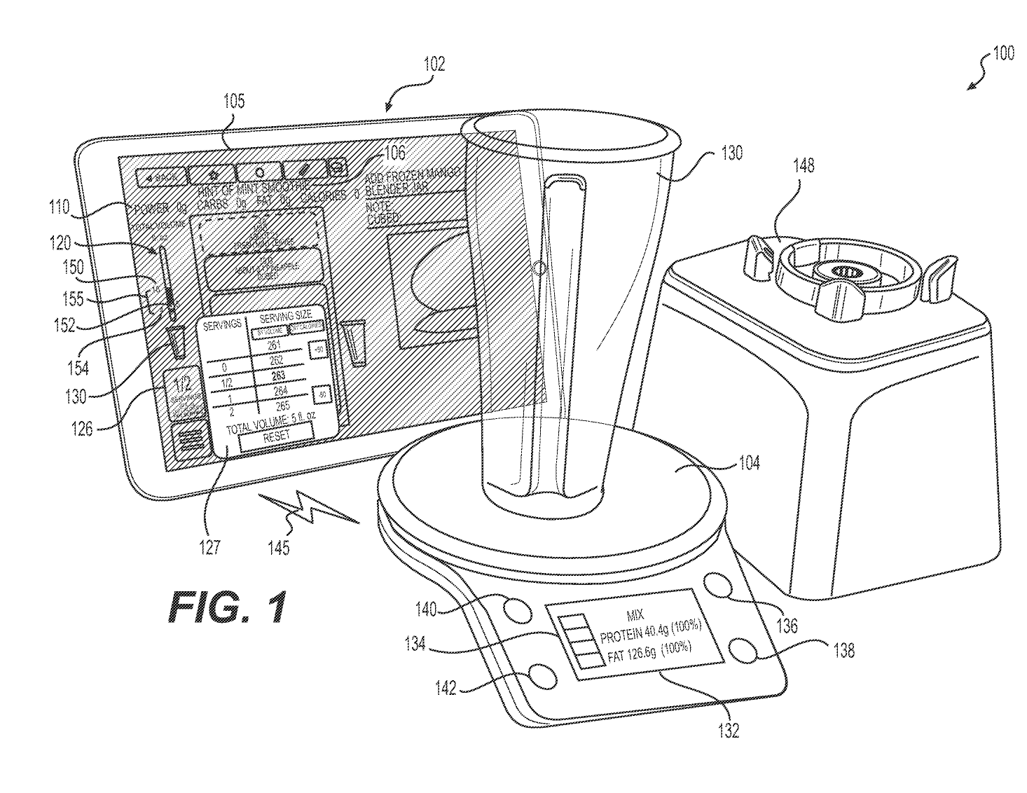

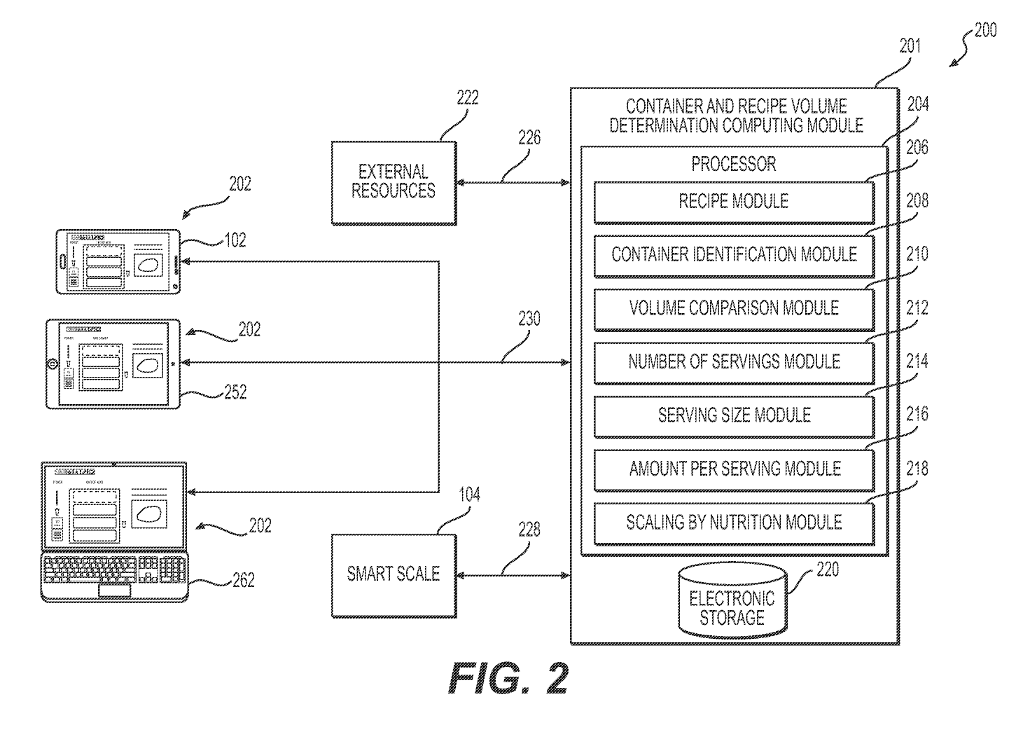

FIG. 1 is an illustrative example of a system 100 that shows a client computing device 102, a smart scale 104, a container 130 placed on the smart scale 104 and a blender 148. The client computing device 102 can be configured to allow a user to access and interact with any component(s) of the system via a smart app 202 (shown in FIG. 2) installed on the client computing device 102. The client computing device 102 includes a user interface 105. The system 100 user interface 105 can present a variety of nutrient amounts, which can be included in or equated with the terms and phrases for conveying nutritional data about recipes, including nutritional information, nutrition information, nutrition data, serving size, number of servings, amount per serving, portions, serving portions, or similar. Nutrient amounts also can include one or more of the number of calories, as well as the weight of protein, carbohydrates, fat, vitamins, minerals, fatty acid, sugar, or another indication of nutrition. Nutrient amounts can be determined for an ingredient, one or more ingredients, a recipe, a number of servings or a serving size of a recipe. The nutrient amounts can also include information relating to additional daily dietary recommendations such as those based on a recommended daily allowance (RDA).

The FIG. 1 user interface 105 also shows the name of the recipe “Hint of Mint Smoothie” 106, a nutritional panel 110 shown just below the recipe name in a row orientation, a depiction of the container 130 and a servings button 126. The user interface 105 also includes a container volume scale 120, labeled “Total Volume,” which includes maximum and minimum target container volumes 150 and 154, respectively, and a recipe volume 152. The volumes 150 and 154 represent the target volumes of the container to accommodate the recipe volume 152 of the recipe ingredients as combined. FIG. 1 also shows a blender 148.

There can be several factors for determining the maximum and/or minimum target container volumes 150 and 154, respectively. For the minimum target container volume 150, one factor can be a minimum volume which can be efficiently blended. In one example, efficiency in blending can depend on a minimum quantity of liquid, dry and/or a combination of liquid and dry ingredients that can be blended. A common form of measurement for efficient blending is the amount of liquid ingredients. For a given container, such as, for an individual serving container, a preset minimum quantity of liquid ingredients can be determined, such as ½ cup or 4 fluid ounces, or ¾ cup or 6 fluid ounces. For another container, such as, for a multiple serving container, a preset minimum quantity of liquid ingredients can be determined, such as 2 cups or 16 fluid ounces, or ¾ cup or 6 fluid ounces. For still another container, the preset quantity can be selected based on the recipe volume 152 as combined, in order to account for a mixture of liquid and solid ingredients. Preset quantities generally for containers 130 can be applied on a container basis, or for a category of containers 130. One example of a category of containers is blender containers. Some blender containers include a blade in the bottom and are oriented upright to receive ingredients. Other blenders in this category do not include a blade in the container itself, and receive recipe ingredients when oriented in an inverted position. A lid containing a blade is then added and the container is reoriented to place the lid in the base of the blender 148. The blade construction for different blender containers 130 can result in different minimum preset quantities. For the vertically oriented blender containers 130, the blade in some constructions can be recessed with a well having a smaller diameter then the diameter of the area of the container above the blade. For the inverted blender containers, with the blade attached to the lid, the diameter of the lid generally is larger than the diameter of the blend container 130 along the height for at least a portion of the remainder of the container 130. These factor can change the preset minimum quantity based on, for example, the container geometry, blade geometry or construction, as well as other characteristics of the blade, placement of the blade and geometry of the container around or above the blade, the surface area of different blades, the area surrounding the blade and/or the blade's interaction with the recipe ingredients. In one example, a vertically oriented container 130 can have a preset higher minimum volume, such as ⅔ cup or 5.33 fluid ounces, versus an inverted container, such as ¼ cup or 2 fluid ounces. In these examples, the preset minimum quantity can be a function of the container 130 or the container category.

Similarly, the system 100 also can use a preset maximum target container volume as a function of the container 130 or the container category. The preset maximum can be a function any of the factors listed above, including as one example the geometry of the container at one or more various points along the length of the container 130, such as the change in diameter along its length. An additional factor can be to accommodate space for a preset maximum quantity versus the total volume capacity of the container 130. In this way, the vibration of the recipe ingredients during blending which can increase the recipe volume 152 can be factored into the maximum target volume. Additional factors regarding combining recipe ingredients also can be analyzed in order to assess the maximum target container volume.

There can be other bases for calculating preset maximum and/or minimum target container volumes for an individual container 130 or a category of containers. In other examples, the container 130 can have preset maximum and/or minimum target container volumes 150 and 154, respectively, as a function of the total volume capacity (i.e., 100% versus 0% container volume) of the container 130. This can be done on a percentage basis, such as preset minimum targets of approximately 10%, 20%, 25%, or similar, or preset maximum targets of approximately 70%, 75%, 80%, 85%, or similar, or a range of percentages including these quantities as examples or ranges in between these quantities, or similar, with blending efficiency being increased as the recipe volume 152 is closer to the target quantities. These preset quantities also can be determined based on experimentation on a per container 130 or category basis. Therefore, the maximum and minimum target container volumes 150 and 154, respectively, need not follow a rule-based approach, but rather can be determined based on testing for specific containers 130 or container categories. There are a variety of calculations or approaches to determining preset maximum and minimum target container volumes for containers 130. In addition, once maximum and minimum target container volumes are determined, for processing, the smart app 202 can determine recipe volumes that are equal to, greater than or less than the volumes. In other examples, the smart app 202 can determine recipe volumes which are within the threshold amount of the maximum and/or minimum target container volumes, such as within 1%, 1.5%, 2% or 5% of the target container volumes, or another measurement as determined based on the particular container or recipe.

In another example, the container 130 maximum and minimum target container volumes 150 and 154, respectively, can incorporate factors related to a recipe 106 as part of the initial determination. In other examples, the recipe 106 then can become a factor where the container 130 and/or recipe 106 have predetermined or identified characteristics. The recipe 106 characteristics can depend upon the recipe's liquid and dry ingredients, the quantities of those ingredient types and/or the ratios of those ingredients types relative to each other. Other ingredient attributes also can be factors, such as an impact on the recipe volume 152 by using voluminous ingredients such as leafy vegetables. This type of ingredient can be contrasted for exemplary purposes with protein powder, which can be fine and/or densely packed. Another factor can be the order in which the ingredients are added to the container 130. The recipe 106 can be written to include one or more liquid ingredients listed first or the recipe 106 can be rewritten to reorder the ingredients. In this case where one or more liquids are added to the container before dry ingredients, the minimum target volume 154 for example can then be lowered. For example, a minimum target volume 154 as a function of the container 130 of 1 cup or 8 fluid ounces can be reduced to ½ cup or 4 fluid ounces. In another example, a recipe 106 can be taken into account when a predetermined percentage of the recipe volume 152 is based on liquids, such as approximately 50%, 60% or 70%, or similar. In yet another example, when a recipe 106 includes proportionally a larger quantity of dry versus liquid ingredients (or vice versa) than recipe 106 proportions generally, the maximum and minimum target container volumes 150 and 154, respectively, can be impacted. This is because the liquid contribution to the recipe volume 152 can impact the pressure within the container 130 during blending. With more liquids than solids (for example, compared to recipe 106 proportions generally), a maximum container volume 150 can be decreased, such as from 3½ cups or 28 fluid ounces to 3 cups or 24 fluid ounces. In a further example, this factor of a recipe 106 can be taken into account when a predetermined percentage of the weight is based on dry ingredients, such as approximately 30%, 40% or 45%, or similar. There are a variety of proportions of liquid versus dry ingredients which can impact the target container volume range 155. The recipe 106 characteristics can be taken into account for predetermined quantities of maximum and minimum target container volumes 150 and 154, respectively, such as, for example, where the maximum target container volume 150 is low or the minimum target container volume 154 is high, so that the proportion of liquid versus dry ingredients can become more impactful.

Several specific attributes of a recipe may be considered when determining the maximum and minimum target volumes 150 and 154 respectively. One such exemplary attribute is the volume of the ingredients. A recipe for Green Smoothie might comprise 4.5 ounces of coconut water, 150 grams of green grapes, 1 gram of mint, 420 grams of pineapple, 135 grams of frozen mango, and 65 grams of spinach. Although the spinach ingredient has a low weight, the low density of spinach means that this ingredient occupies a large volume before processing. As a consequence, for this recipe, the allowable volume range for a 64 ounce container might be from 16 ounces to 40 ounces, since attempting to mix more volume than this would result in the overflowing the container. By comparison, for a Buttermilk Smoothie comprising 4 ounces of buttermilk, 33 grams of dates, 125 grams of banana, 0.07 ounces of honey, and 120 grams of ice, the allowable volume range for a 64-ounce container might be from 16 ounces to 48 ounces, since the Buttermilk Smoothie recipe would not overflow the container even with a larger volume of ingredients.

Another exemplary attribute of a recipe that may be considered when determining the maximum and minimum target volumes 150 and 154 respectively is the viscosity of the final processed recipe. A Frozen Desert recipe might comprise 1 ounce of milk, 0.42 ounces of vanilla extract, 30 grams of cream cheese, 115 grams of brown sugar, 0.5 teaspoon of pumpkin pie spice, 240 grams of pumpkin, and 450 grams of ice cubes. This recipe has a relatively high viscosity, as it is intended to be a frozen dessert eaten with a spoon, and therefore might have an allowable volume range for a 64-ounce container of 16 ounces to 40 ounces. A larger volume of ingredients would not permit proper mixing in this container. By comparison, a recipe for Almond Milk comprising 16 ounces of water and 100 grams of almonds would have a low resulting viscosity, and might have an allowable volume range for a 64-ounce container of 16 ounces to 56 ounces.

Yet another exemplary attribute of a recipe that may be considered when determining the maximum and minimum target volumes 150 and 154 respectively is the final goal of processing for the recipe. A recipe for a hot soup may rely on frictional heating provided by blending the ingredients for a sufficient time at a sufficient speed. Too small a volume of liquid might cause air to be whipped into the final result, reducing the generated friction. Too large a volume of liquid might result in inadequate heating of the ingredients. In either case the result would be undercooking, yielding an undesirable end product. Accordingly, for a typical soup recipe the allowable volume range for a 64-ounce container might be 32 ounces to 40 ounces.

In further examples, the maximum and minimum target container volumes 150 and 154, respectively, for a container 130 or a category of containers can be calculated as a function of both the container 130 and the recipe 106. The contribution of each of these factors can be the same or one factor can be applied more predominately than another. For example, the preset volumes can be identified for the container 130 and then the recipe 106 can be assessed for adjustments to the quantities based on the container 130. As discussed above, one primary factor for the recipe 106 that can impact the maximum and minimum target container volumes 150 and 154, respectively, are the proportions of liquid and dry ingredients. For one exemplary recipe 106, a large quantity of leafy ingredients, (such as, for example, salad greens) in comparison to the remainder of the recipe ingredients can overflow the container 130 before blending. Therefore, the preset maximum target volume 150 for the container 130 can be reduced as a function of the recipe 106, as described above.

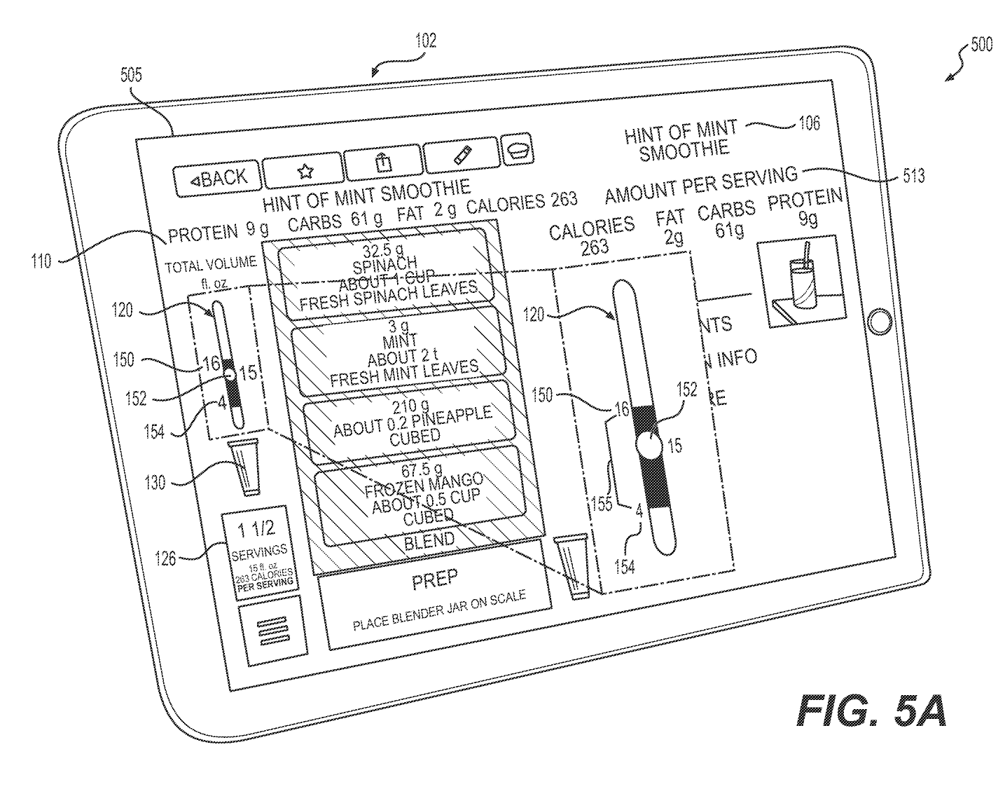

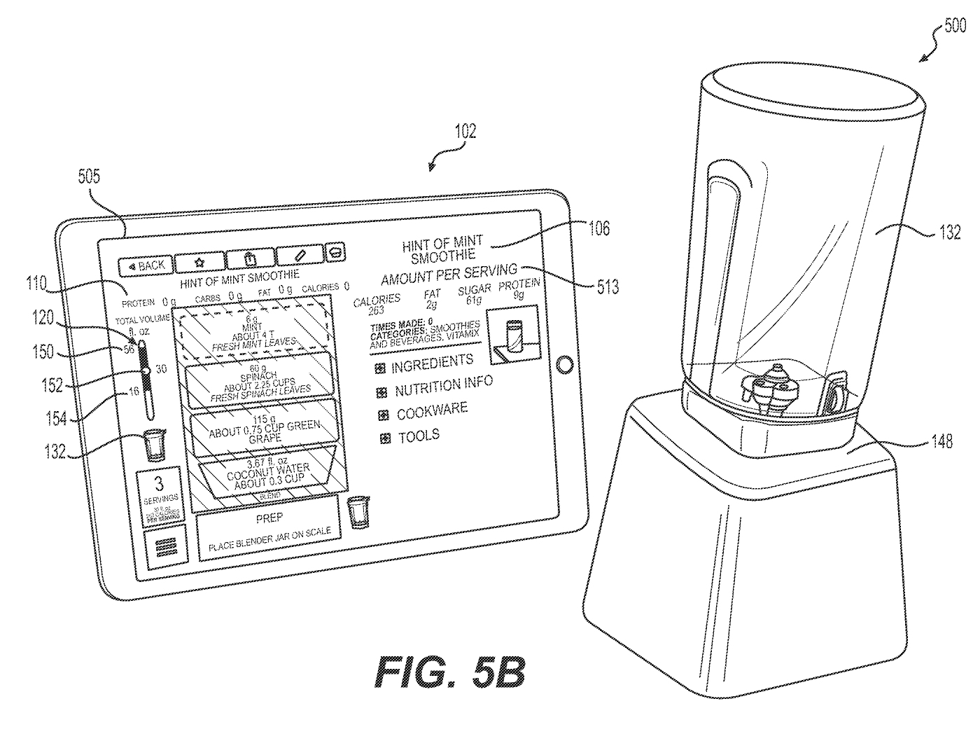

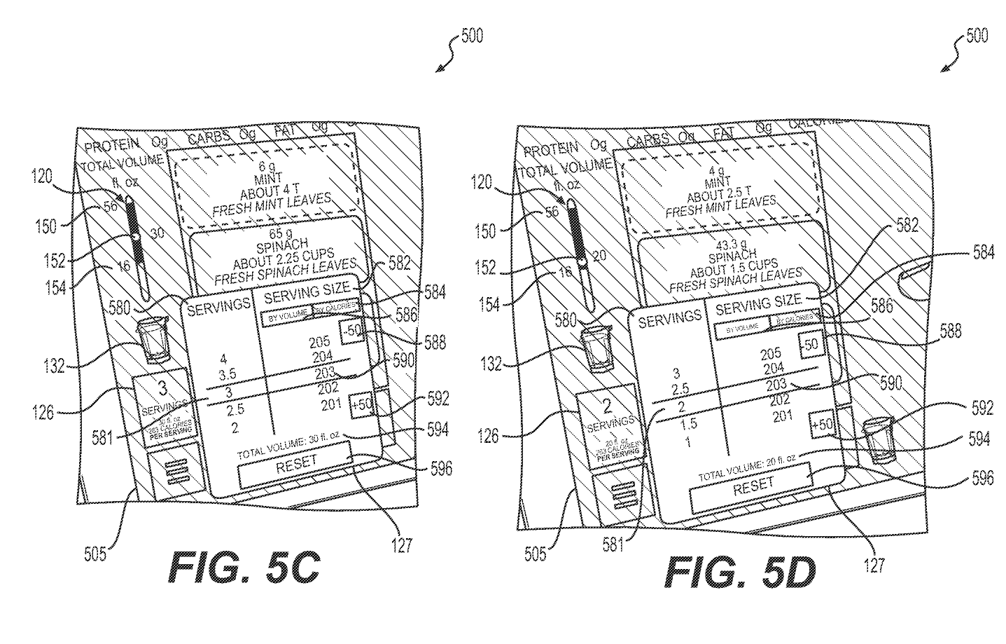

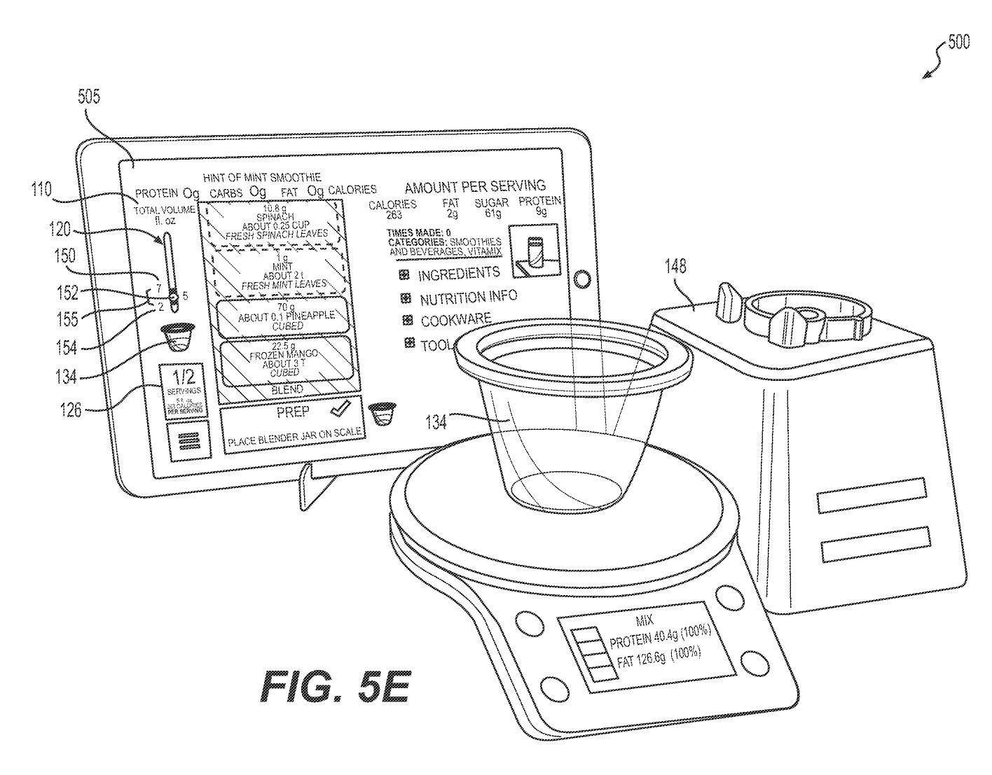

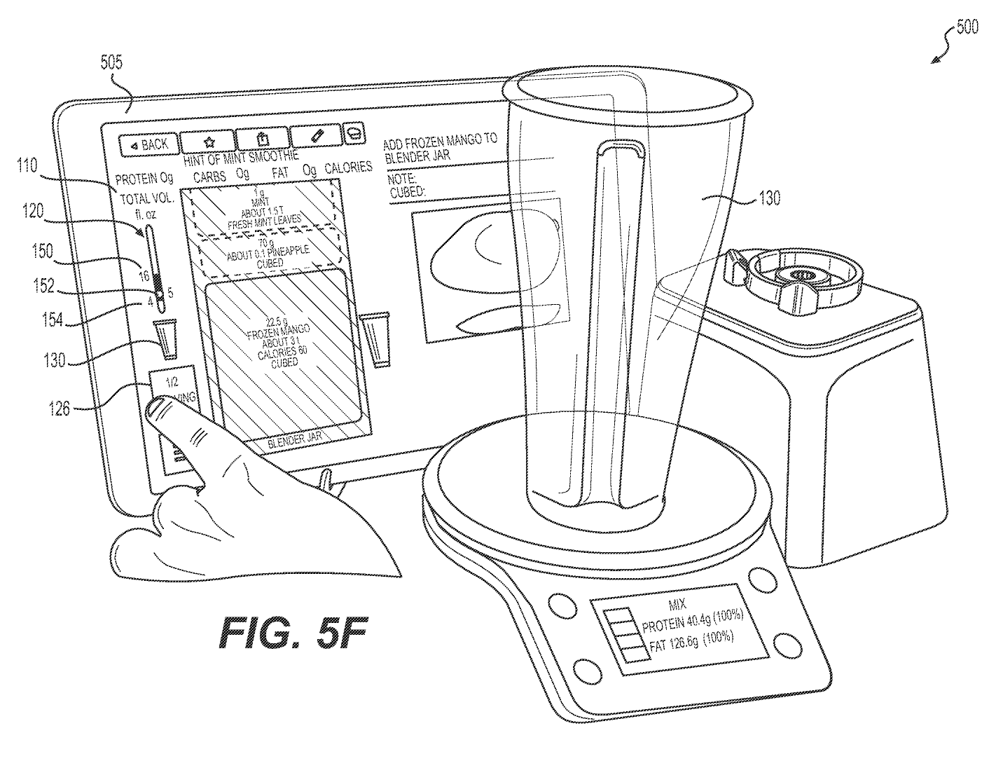

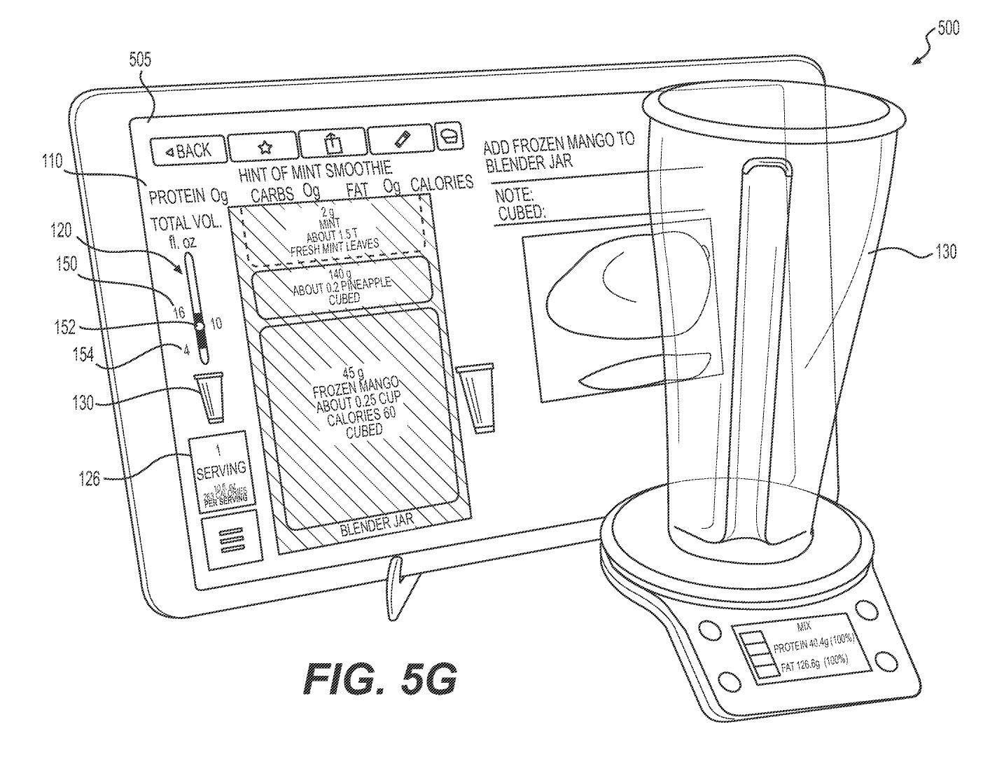

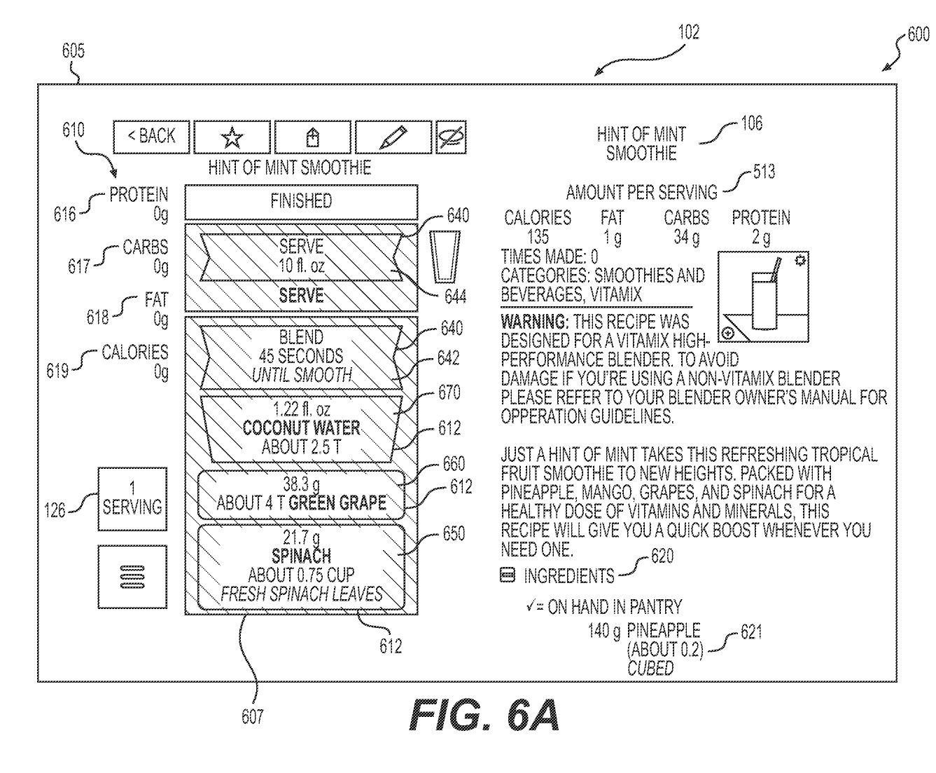

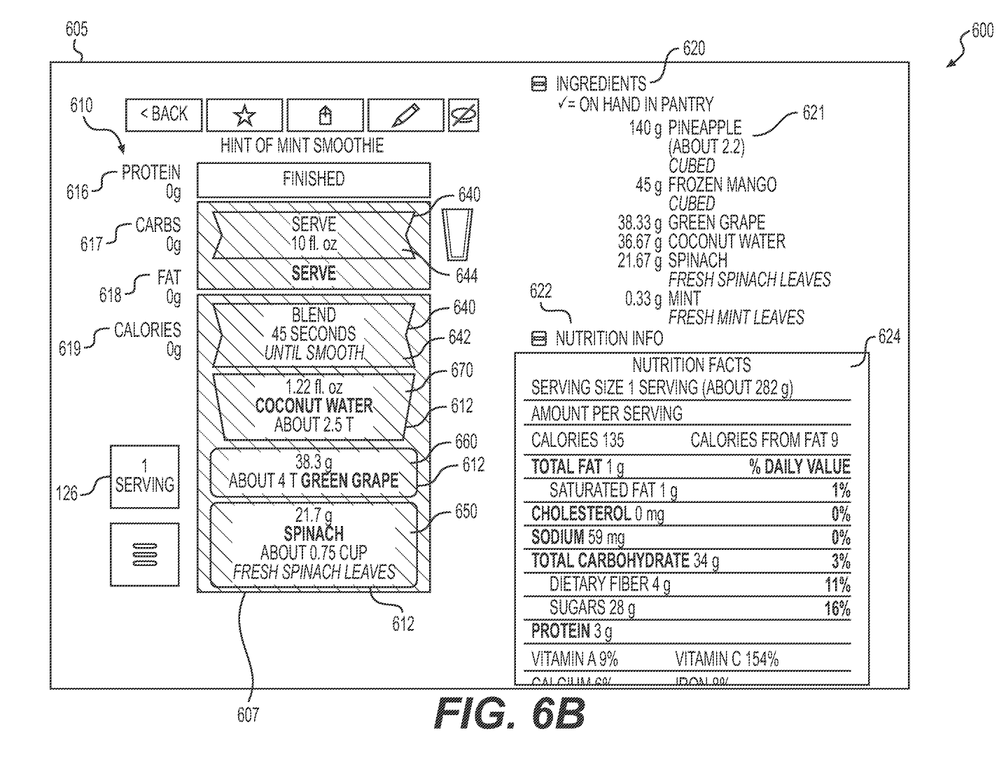

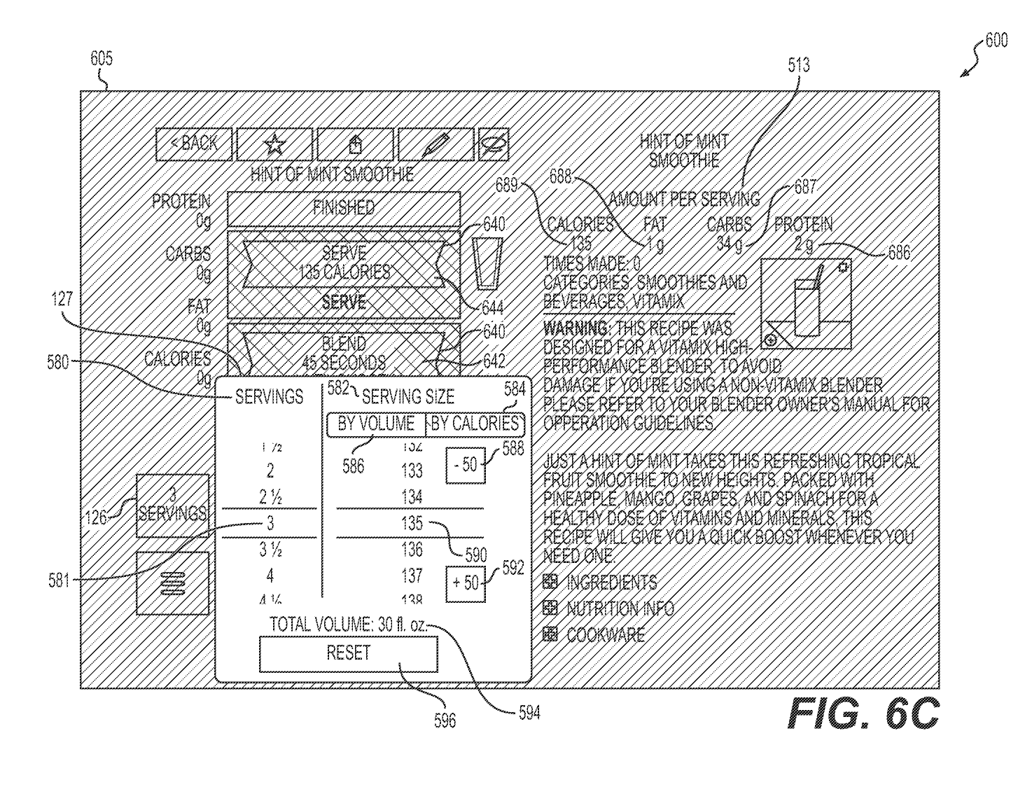

The user interface 105 of FIG. 1 also shows an activation of the serving button 126 within a first display, which can prompt another display or a second display. The additional or second display is a servings button adjustment panel 127. It can support changes to a variety of nutrient amounts related to the recipe 106, including the number of servings and servings size. The serving button adjustment panel 127 is further described regarding FIGS. 5C-5D and 6C. Nutrient amounts further can be shown in other areas of the user interface 105, including in the nutritional panel 110, and the data displayed in the first and/or second display can be exchanged or different data can be shown on the first and/or second display. The nutritional panel 110 can include one or more nutrient amounts, including for example, protein, carbohydrates, fat and the number of calories. The display of the nutrient amounts, whether in an expanded panel, such as the serving button adjustment panel 127, or on the initial user interface 105, can be designed in a variety of formats. For example, the servings button adjustment panel 127 can be shown as part of the user interface 105 without the need to expand the serving button 126. Also, various portions of the first and/or second display can be rearranged or omitted based on the variety of nutrient amounts sought to be displayed relative to the container 130 identification and the recipe 106 volume, as well as a variety of design decisions. The user interface 105 of system 100 supports a range of approaches for presenting the maximum and minimum target container volumes 150 and 154, respectively, recipe volume 152 and other one or more nutrient amounts.

The scale 104 also can be incorporated into the blender 148 (an incorporated scale is not shown) so that the container 130 can be identified, ingredients added and the recipe 106 executed with the container 130 mounted in the blender 148. FIG. 1 shows the scale 104 as a separate component from the blender 148. The smart scale 104 shown in FIG. 1 can include a display interface 132 that shows the amount of recipe 106 ingredients as they are added to the container 130 and an action to be executed for the current ingredient being added or to be added next (in this example, the action is “Mix”). The adjustments can be detected for individual ingredient(s), including one ingredient or a combination of ingredients. The term “execution” or “execute” as used herein, includes preparing (or making) a recipe or adding an ingredient as part of preparing a recipe.

The display interface 132 also can show a portion or all the data provided on the user interface 105, including the nutrient amounts shown on the nutritional panel 110, recipe 106 ingredient information and nutrition information (shown in FIG. 6B as “ingredients” 620 and “nutrition info” 622). The display 132 can provide nutrient amounts on a per ingredient basis in other examples. The display also can be customized by the user executing customization options on the smart app 202. The smart scale 104 can also provide programmable or predefined hardware buttons for enabling various options such as an Up button 136, Down button 138, Power button 140, and a Bluetooth button 142, among others.

The smart scale 104 and the client computing device 102 can have one or more processors configured to execute various functions, operations, commands, functionalities, processes, and computer modules. In other examples, the system 100 can utilize other devices or locations for executing the various functions described above. The system 100 can use the scale 104, computing device 102 and smart app 202 to execute various functions, including, for example, receiving data from the smart scale 104 and processing the data to provide container 130 identification and recipe 106 alignment based on volume. Additional functions can include receiving data entry on the user interface 105 to change recipe 106 nutrient amounts and adjusting the recipe based on the change. Still additional functions can include receiving data entry on the user interface 105 to change the number of servings and adjusting the volume 152 of the recipe 106 based on the change.

Such other devices can include processors remotely accessible by the smart scale 104, such as additional device(s) that can communicate with the scale 104, or a user interface 105 integrated into the scale 104 or as part of another device independent of the scale 104. The scale 104 also can include a portion or all the processing capabilities, or the processing can occur on the basis of a distributed network with portions of or full processing implemented in one or more server(s), which are distributed within a network between remote devices. One example of a communications channel is shown in FIG. 1 as a network 145.

The smart scale 104 as a standalone component, or as integrated into the blender 148, can also include notification or feedback systems in the form of optical and audio signals or alerts that can be used to assist the user when performing an operation, such as adding a new container 130 to the scale 104 or to the blender 148 that also can measure the container 130. Audio or visual prompts for the user can be activated from the client computing device 102, the smart scale 104 and/or the blender 148. For example, the system 100 can talk a user through container 130 identification and recipe 106 execution. Timers also can be set for actions requiring timing. These timers can be displayed on the client computing device 102, the smart scale 104 or a display on the blender 148. An optional microphone on the smart scale 104, blender 148 or the client computing device 102 can be used for voice prompts/commands. The smart scale 104 can also be configured to use one or more types of connectors such as an audio jack, Bluetooth, USB, or similar, and standard or custom communication protocols.

The client computing device 102 can include the user interface 105, one or more processors, electronic storage, and other components. The client computing device 102 can include one or more of the following: a desktop computer, laptop computer, handheld computer, tablet computing platform, netbook, smartphone, and other computing platforms. The client computing device 102 can send commands to, or receive requests or prompts from, the smart scale 104 as a standalone component or as part of the blender 148.

The user interface 105 on the client computing device 102 can show various types of information in approximately real-time, such as, the current container 130, the maximum and minimum target container volumes 150 and 154, respectively, for the container 130, the target container volume range 155 and the current recipe 106 volume 152. As used herein, “approximately real-time” is used to indicate processing as quickly as is practicable, and/or as can be achieved within the capability of human interaction or responses in the utilization of the methods and systems. The processing also is impacted by the latency inherent with communication protocols, hardware limitations, and software execution. The smart app 202 can also display a comparison between the target container volumes 150 and 154, respectively, and the recipe volume 152. The detection and identification of containers 130 and the resulting display of data about the containers 130 can occur on an approximately real-time basis. In one example, the system 100 includes at least one display integrated with the smart scale 104 and/or blender 148 and at least one other display that forms part of a client computing device 102. In another example, the system 100 operates based on a single display, such as the user interface 105. One or more displays can be used to provide various types of information that facilitate container detection and recipe alignment based on volume. The smart scale display 132 can also show approximately real-time information that includes the connection status of the smart scale 104 with the client computing device 102.

The user interface 105 also can be configured to provide interface functionality to the user and at least one client computing device 102 through which the user can provide information to and receive information from the system 100. This enables data, user comments, feedbacks, alerts, results, queries, instructions, or similar, herein collectively referred to as “information,” to be exchanged between the user and system 100. Examples of user interface 105 hardware and/or software components include a touch screen, keypad, touch sensitive and physical buttons, scales, graphs, switches, keyboard, knobs, levers, display, speakers, microphone, indicator light, audible alarm, printer, and other interface devices. In some system implementations, the user interface 105 can include any one of a plurality of separate or integrated or related portions of interfaces. In one example, the user interface 105 can include a first display for the container volume scale 120, recipe volume 152 and related data, and a second display for the serving button adjustment panel 127. In further examples, a user interface 105 can refer to software, hardware, a combination of hardware and software, or a device with a primary function of allowing communications or interactions between two or more devices or between a user or a plurality of users and one or more devices. A user interface 105 can be configured such that a user can navigate through electronic folders, databases, servers, networks, and various local or external storage media to locate, view, select, or store the recipes and/or the container information.

The system 200 shown in FIG. 2 to support the computing environment of FIG. 1 is now described. FIG. 2 is a schematic diagram of an illustrative computing environment 200 showing components that communicate to enable various operations involving a smart scale 104, a computing module 201, and one or more client computing devices, such as the client computing device 102 shown in FIG. 1.

The computing module 201, titled “Container and Recipe Volume Identification Computing Module,” can be implemented in a smart app 202. The smart app 202 can be installed on one or more client computing devices 102, 252, and 262, or similar. The computing module 201 can include at least a processor 204, the recipe module 206, the container identification module 208, the volume comparison module 210, the number of servings module 212, the serving size module 214, the amount per serving module 216, the scaling by nutrition module 218 and an electronic storage 220. The recipe module 206 can process data about the recipe 106, the recipe volume 152, and nutrient amounts for either the recipe 106 and/or its ingredients. The computing module 201 can further include the container identification module 208 for processing the use of the smart app 202 to identify a variety of containers 130 and their respective maximum and minimum target container volumes 150 and 154 and the container volume range 155. The volume comparison module 210 can determine the container volume range 155 in comparison to the total recipe volume 152 in order to determine whether the recipe 106 can be made in the container 130. The number of servings module 212 can process the default number of servings (shown in FIG. 5C as the servings 580 on the servings button adjust panel 127 and on the servings button 126) for the recipe 106, as well as changes to the number of servings. The number of servings also is shown on the servings button 126. The serving size module 214 can process the recipe serving size as the default serving size of the recipe as originally written, and/or changes to the serving size 582 (shown in FIG. 5C as the serving size 582 on the servings button adjust panel 127). The amount per serving module 216 can process the recipe “amount per serving” 513 collection of nutrient amounts and/or changes to the amount per serving 513 (shown in FIG. 5A). The scaling by nutrition module 218 can process changes to the serving size as reflected in the amount per serving and nutrient amounts, in modules 214 and 216, respectively, based on user input detected on the user interface 105. As the user interface 105 detects changes to recipe as originally written, such as changes to nutrient amounts, the changes can result in scaling of the recipe 106 based on the nutrient amount. The recipe scaling can then change the recipe volume 152 to be within the target container volume range 155.

The client computing device 102 can engage in two-way or one-way communications with the smart scale 104 (using communication connection 228), one or more external resources (using communication connection 226), and the smart app 202 in one or more devices 102, 252 and 262 (using communication connections 230). The communication connections 226, 228 and 230 can be wired or wireless and can be one-way or two-way. In another example, a smart scale 104 using a two-way link (not shown) with devices 102, 252 and 262 can provide even more functionality. The computing module 201 can include one or more algorithms, software, a component of a software, or a database that performs, or is involved in the performance of, one or more operations including for example calculating values, retrieving data, storing data, editing a file, deleting files, transmitting data or instructions, receiving data or instructions, displaying various types of information or data, processing data, and allowing communication between two or more devices, servers, or networks.

The smart app 202 can be configured to transmit or receive approximately real-time information to or from the smart scale 104. The smart app 202 can be installed on a variety of client computing devices 102. Examples of such devices are shown in FIG. 2 and include devices 102 (a mobile phone), 252 (a tablet) or 262 (a laptop), or similar. In yet further examples, the smart app 202 can be installed on the scale 104 or on a separate hardware and/or software platform. In yet a further example, portions of the smart app 202 processing can occur in multiple components. The smart app 202 can access information, such as through the electronic storage 220, relating to containers, recipes, volumes and nutrient amounts, including a number of servings, serving size, amount per serving and/or changes to such data, or similar. The smart app 202 can further access information relating to substitutions, actions, notifications and schedules. The smart app 202 can access information from local, and external and/or online databases. The smart app 202 can also present a user with a user interface 105 that provides menus and menu options. The user interface 105 can also provide means for entering, searching, storing, and identifying user inputs, information and data. Such user inputs, information and data can include actions to be performed, an identification of containers, an identification of recipes, a receipt of recipes and/or changes to any of the following: the recipe number of servings, the recipe serving size, nutrient amounts and/or ingredients, or similar data. The smart app 202 can be configured to receive commands or instructions via various methods for user inputs such as using a touchscreen display, keypad, keyboard, or voice-commands, visual commands, and similar. For example, the smart scale 104 can have a button pad that allows transmission of instructions or commands to the smart app 202, or vice versa.

The smart app 202 can be further configured to assist the user in processing containers 130 and recipes 106, and nutrient amounts relative to the recipes 106. The smart app 202 can support data generation about a container's volume range 155 based on data detected at the scale 140. The smart app 202 can further compare the container volume range 155 to the volume 152 of the recipe 106. When containers 130, recipes 106 and nutrient amounts of recipes are changed, the smart app 202 can automatically recalculate and display the new container 130, the new container volume range 155 and recipe volume 152 and the adjustments to the recipe based on the changes to the nutrient amounts. Then, during recipe 106 execution, the smart app 202 can detect if a user adds too much or too little of each ingredient and can promptly notify the user for confirmation. The smart app 202 also can then assist the user to detect an intentional ingredient adjustment versus an error such as based on a period of user inactivity detected by the user interface 105. A period of user inactivity can follow the smart app 202 receipt of entry or selection of data and then the expiration of a timed preset period to detect further data entry or selection, such as 5 seconds, 10 seconds, or similar. The smart app 202 then can display data about the impact of such changes on the recipe volume 152 and the comparison to the container volume range 155.

In one system 100 implementation, the container 130 and recipe volume 152 identification computing module 201 and external resources 222 can be configured such that receiving data entry or selection of a container 130 can include reading, scanning, and optically recognizing information that identifies individual or a range of containers 130. For example, external resources (not shown individually) and a client computing device 102 can include a scanner controlled via a user interface 105 configured to recognize a standard barcode, QR code, RFID tag, or other identifying information included on the packaging of one or more container(s) 130. An external resource, the client computing device 102, or the smart scale 104 can include optical recognition sensors controlled via the user interface 105 that are configured to optically recognize individual containers 130. Scanning container 130 identification data can provide a convenient way for the system to readily ascertain container 130 data.

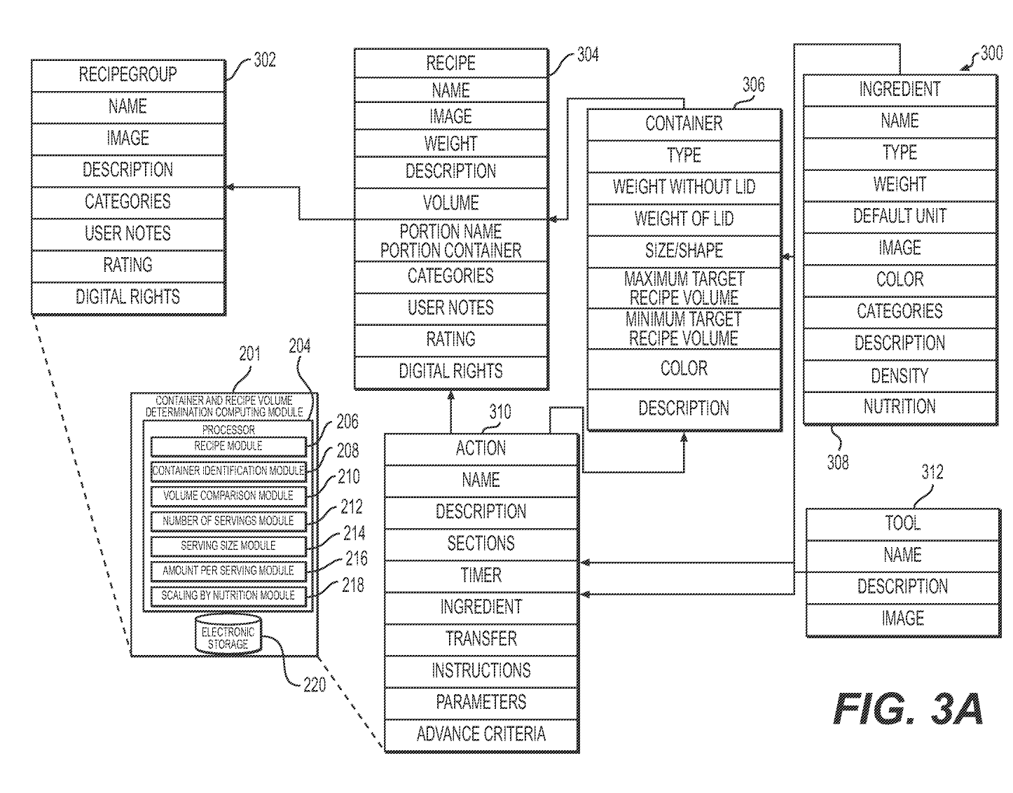

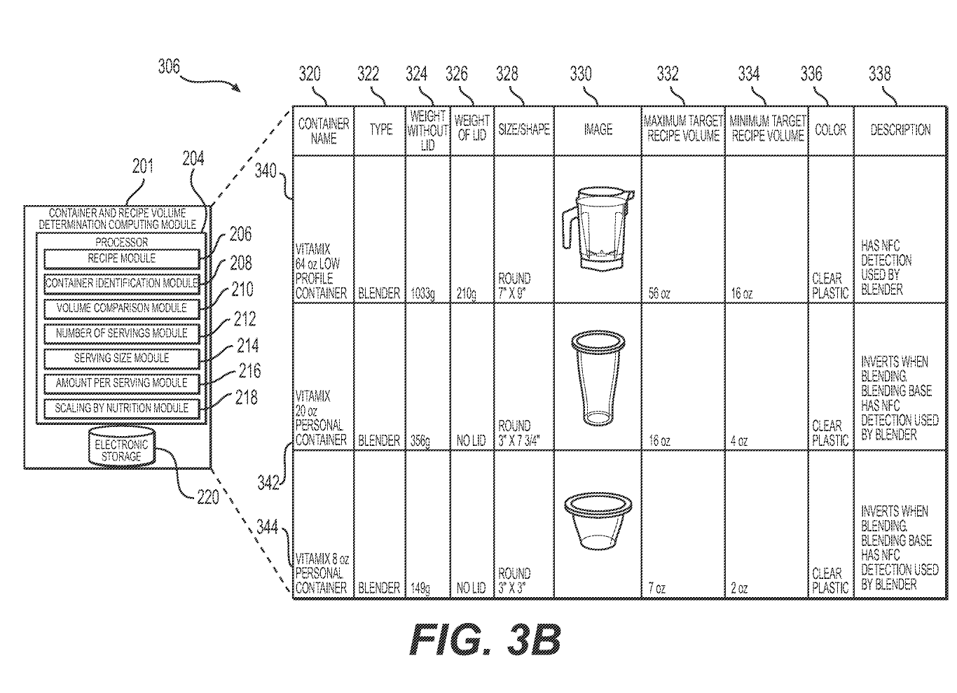

FIG. 3A is an illustrative data structure 300 showing the data flow among various data sets associated with container 130 identification and recipe 106 alignment based on volume. The data sets include as follows: recipe group data 302, recipe data 304, container data 306, ingredient data 308, action data 310 and tool data 312, which encompass the comprehensive data for use in the system 100. Each of the data sets, 302, 304, 306, 308, 310 and 312 also includes specific data (for example, name, portion name and portion container, weight and volume for the recipe data 304, name, weight, maximum and minimum target container volume for container data 306 and weight for ingredients data 308) that can be transmitted to or shared with other data sets to allow the processing of various data, and information to generate output information for the user of system 100. Examples of output information are: a message, alert, update or the result of a calculation. More particularly, the output information can result from receiving data on the user interface 105 based on one or more operations, such as container 130 identification and recipe 106 alignment based on the recipe volume 152. Another operation, which can occur individually or in combination with other operations, is the receipt based on user data entry or selection on the user interface 105 of a desired recipe measurement. The desired recipe measurement can be one or more nutrient amounts, which can prompt an adjustment of the recipe 106 number of servings, amount per serving, total volume, other serving data, or similar.

The processing of data can be triggered as a result of a user command, user input, recipe-prescribed user action, or user selection from a smart app 202 menu or menu options via the user interface 105, or one or more signals detected by one or more system sensors, or similar. The data sets 302, 304, 306, 308, 310, and 312 show various data and information, such as names, images, descriptions, categories, user notes, ratings, digital rights, portion names, portion, containers, types, weight, maximum and minimum target container volume, recipe volume, size or shape, color, default unit, density, nutrition, sections, timer, transfer, instructions and parameters. The data sets can be stored in the same or different electronic storage media, or similar. The container data 306 is now described more fully. The container data 306 can include: container 320, type 322, weight without a lid 324, weight of lid 326, size/shape 328, image 330, maximum target recipe volume 332, minimum target recipe volume 334, color 336 and description 338. As shown in FIG. 1, as a container 130 is detected on the blender 148, the image 330 of the container 130, the maximum target recipe volume 332 and the minimum target recipe volume 334 can be shown on the user interface 105. The exemplary container data 306 shown in FIG. 3B include several exemplary containers, including three containers 130 produced by Vitamix™. The container names 320 are Vitamix 64 oz Low Profile Container, Vitamix 64 oz Low Profile Container and Vitamix 8 oz Personal Container. The maximum and minimum target recipe volumes 332 and 334 are 56 ounces and 16 ounces, respectively, for the Vitamix 64 oz Low Profile Container, 16 ounces and 4 ounces, respectively, for the Vitamix 64 oz Low Profile Container and 7 ounces and 2 ounces, respectively, for the Vitamix 8 oz Personal Container, respectively. The container data 306 also includes size and shape dimensions 320 and also presents descriptions, such as whether the container is an inverted container, as shown for the Vitamix 64 oz Low Profile Container. There are a number of approaches to determining the maximum target container volume 150, including receiving them from the container data or calculating them based on the approach described above for FIG. 1.

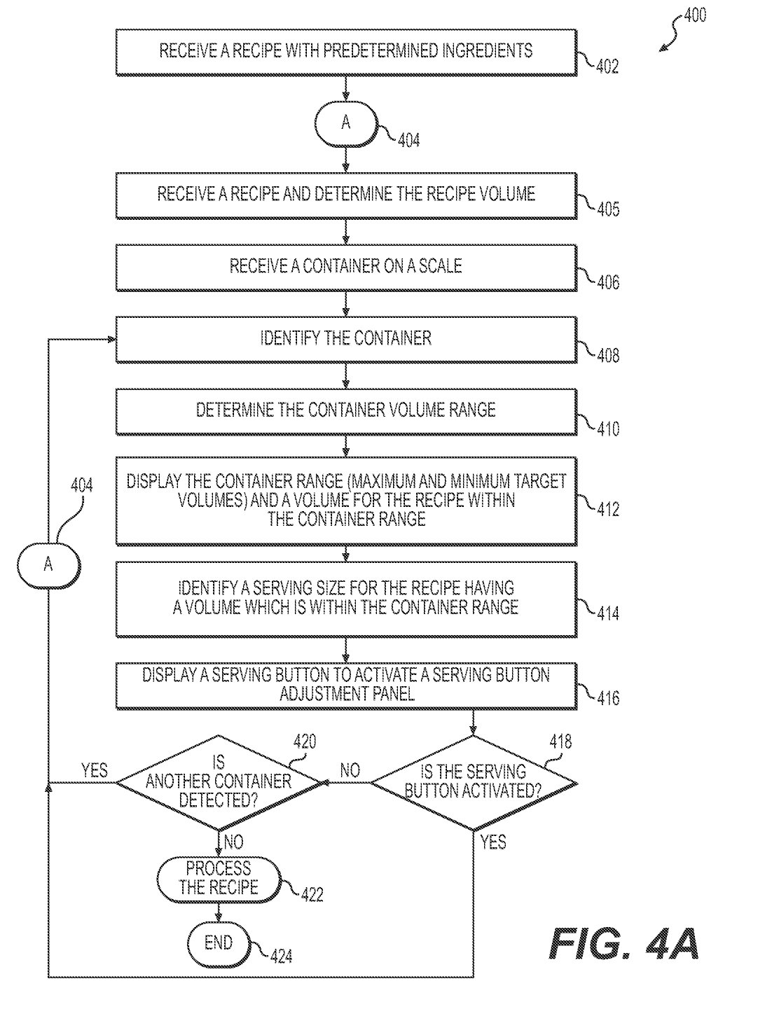

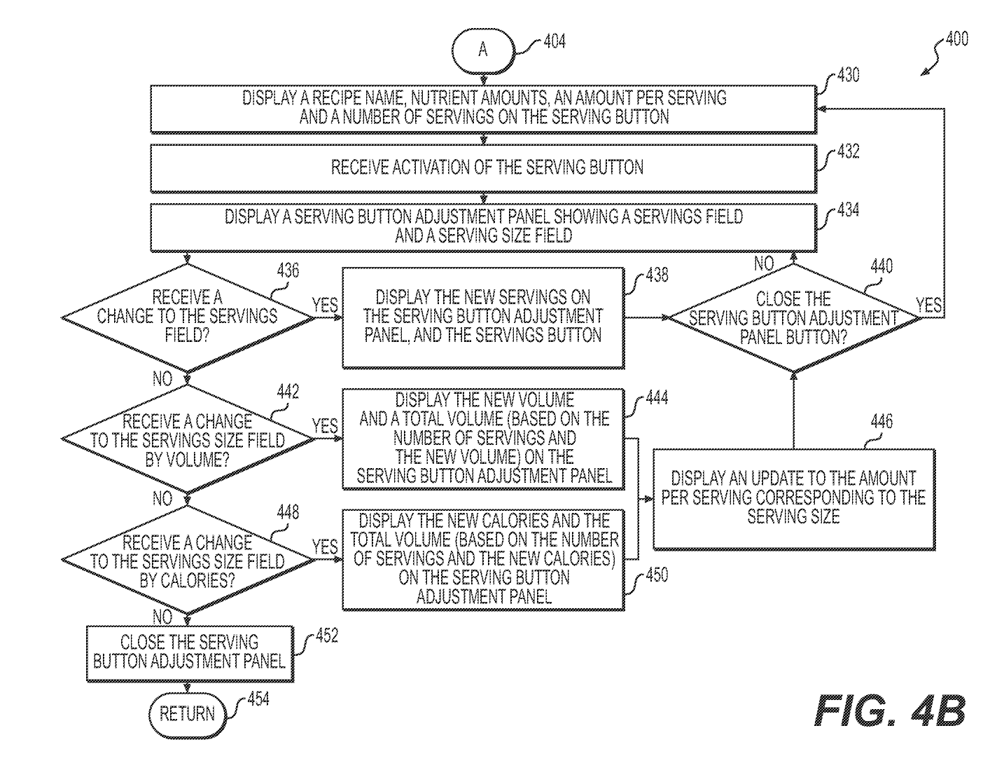

FIG. 4A is a flow diagram showing a process 400 for receiving a recipe 106 with predetermined ingredients 308 and a volume 152, as well as identifying a container 130 in which the ingredients can be combined. The process further can include displaying the maximum and minimum target recipe volumes 150 and 154, respectively, compared to the recipe volume 152. The process 400 is illustrated as a collection of blocks in a logical-flow graph, which represents a sequence of operations that may be implemented in hardware, software or a combination thereof. The blocks are referenced by numbers 402-416. Each of the operations 418 and 420 represents the processing of a query with two paths for subsequent processing, including an affirmative answer to the query and, alternatively a negative answer to the query. The components shown in FIG. 1 are used in describing the processing of FIGS. 4A and 4B.

In operation 402, recipe 106 information is received that indicates predetermined ingredients 308. Predetermined ingredient 306 data collected in operation 402 is processed through subprocess A 404 for use in operations 405-416. At operation 406, data associated with a container 130 being placed on the scale 104 is determined. At operation 408, the container is identified. At operation 410, data associated with the container 130 volume is received. The container volume is represented on the container volume scale 120 (as shown in FIG. 5A). Recipe information received in operation 402 (including determining the recipe volume 152) is then combined with container 130 volume data and processed in operations 408-410. Data received in operations 402, 408, and 410 is then processed at operation 412, whereby the system determines the container volume range 155, expressed as the range of maximum and minimum target container volumes for optimized processing in the container 130. Operation 412 then determines whether the recipe volume 152 for the recipe is within the container volume range 155. The data processed in operation 412 is then displayed on an information panel presented on a user interface 105 of computing device 102. This data can be presented on an approximately real-time basis. At operation 414, the data collected in operation 412 is processed to identify a serving size for the recipe 106 which is within the container volume range 155. In some examples, the identification can include an adjustment to the number of servings of the recipe 106 to calculate a recipe volume 152 which is within the container volume range 155. In other examples, where the volume 152 of the recipe falls outside of the maximum and/or minimum target container volumes 150 and 154, respectively, a notification can be displayed on the user interface 105 alerting the user to the recipe volume 152 being outside of the container volume range 155 (or, in other examples, being greater than the maximum target container volume 150 or less than the minimum target container volume 154). These examples provide alternative processes by which the recipe volume 152 can be aligned with the container volume range 155.

Once the updated data for the serving size (shown on button 126) of the recipe 106 and the container volume is received from operation 412, operation 416 is triggered. At operation 416, the servings button 126 used to activate the serving button adjust panel 127 is displayed on the user interface 105. Then, at operation 418, the system 100 queries the user interface 105 to determine whether the servings button 126 has been activated. If it has (or an affirmative input is received), subprocess A 404 is invoked, which returns the process to operation 408. If it has not (or a negative input is received), operation 420 is invoked, whereby the scale 104 is monitored to detect, based on a weight measurement, the placement of another container 130. Upon detection of another container 130 (or an affirmative input is received), subprocess A 404 is invoked, which returns the process to operation 408. As per operation 408, operations 408-416 are repeated with input from subprocess A 404. However, at operation 420, if no additional container 130 is detected (or an affirmative input is received), then operation 422 is prompted. Operation 422 initiates processing of the recipe. Operation 424 ends the process.

FIG. 4B is a flow diagram showing a continuation of the process 400 in which a number of servings can be predetermined or based on maximum and minimum target container volumes 150 and 154, respectively (also presenting the container volume range 155). The process 400 is illustrated as a collection of blocks referenced by numbers 430-454. Each of the operations 436, 440, 442, 448 represents the processing of a query with two paths for subsequent processing including an affirmative answer to the query and, alternatively, a negative answer to the query. Subprocess A 404 is denoted by an oval.

At subprocess A 404, the following data is collected: recipe 106 data with predetermined ingredients, a recipe 106 name (such as, “Hint of Mint Smoothie”), one or more nutrient amounts as part of an amount per serving 513 (shown in FIG. 5A) of the recipe 106 and a number of servings for the recipe (as shown on the servings button 126). The data is collected at operation 430. The process then is continued upon the receipt on the user interface 105 of an activation of the servings button 126 at operation 432. Once the serving button is activated at operation 432, the system 100 then displays a servings button adjust panel 127 showing a servings field 580 and a serving size field 582 (as shown in FIGS. 5C and 5D) at operation 434.

At operation 436, the user interface 105 is monitored to determine whether data is received based on input received at the user interface 105 to make a change to the servings field 580, such as entry or selection of a new quantity. If data is detected (or an affirmative input is received), operation 438 is invoked, whereby the change to the servings field 580 on the servings button adjust panel 127 and the serving button 126 is displayed. If data is detected (or an affirmative input is received), this also can cause a change to other nutrient amounts, including the nutrient amounts shown on the nutritional panel 110. At operation 440, the user interface 105 is monitored to determine whether data is received based on input to close the serving button adjustment panel 127. If data is detected to close the serving button adjustment panel 127 (or an affirmative input is received), the system 100 closes the panel 127. Then, the process 400 returns to FIG. 4B, whereby operation 430 et seq. is repeated. This in effect creates a repetitive monitoring function for a detection of user input on the user interface 105. However, at operation 440, if no data entry is detected (or the detection of data is negative), the process returns to operation 434. The processing then continues again at operation 436, with monitoring of the servings field 580.

Where no data is detected (or the detection of data is negative) at operation 436, the processing then continues at operation 442. Then, at operation 442, if data is detected (or an affirmative input is received), operation 444 is invoked. In operation 444, whereby the changes to the servings size field 582 by volume 586 (shown in FIGS. 5C and 5D) are displayed, the new volume 152 as entered or selected also is displayed. Also, a volume total 594 is determined based on the number of servings shown on the servings button 126 and the new volume 152. The calculated total volume is labeled “Total Volume.” This also can cause a change to other nutrient amounts, including the nutrient amounts shown on the nutritional panel 110. At operation 446, the user interface 105 also displays updates to the amount per serving 513 corresponding to any changes to the serving size field 582. However, the user interface 105 maintains the number of servings in the servings field 580 as this can be independent of changes to the servings size field 582 by volume 586. In other examples, the number of servings (also shown on the servings button 126) or other nutrient amounts also can be changed. The processing then returns to operation 440, as described above.

Returning to operation 442, where no data input is detected (or the detection of data is negative), the processing then continues at operation 448. Then, at operation 448, if data is detected (or an affirmative input is received), operation 450 is invoked, whereby the changes to the servings size field 580 by calories 584 on the servings button adjust panel 127 are displayed, as well as the new volume 152 and a new total volume 594. In addition, where multiple changes are made to recipe 106 desired number of servings or serving size measurements, another new total volume can be generated. This also can cause a change to other of the nutrient amounts, including the nutrient amounts shown on the nutritional panel 110. At operation 446, once again, the user interface 105 displays updates to the amount per serving 513 corresponding to the serving size field 590 and maintains the number of servings shown on the servings button adjust panel 127 and the servings button 126. In other examples, the number of servings shown on the servings button 126 also can be changed. The processing then returns to operation 440, as described above. Returning to operation 448, where no data is detected (or the detection of data is negative), the processing then continues at operation 454. Then, at operation 454, the system 100 returns processing to FIG. 4A.

FIGS. 5A-5G are an illustrative example of a system 500 that shows a user interface 505 of the client-computing device 102, such as a tablet, which can present options for adjusting the number of servings (shown on the servings button 126) of a recipe 106. The “Hint of Mint Smoothie” recipe 106 is shown for illustration purposes. The user interface 505 includes a recipe nutritional panel 110. After container 130 identification and during recipe execution, the nutritional panel 110 displays the accumulating ingredient data for one or more nutrient amounts based on the weight measurement of each ingredient as it is added to the scale 104. The nutrient amounts shown in this example, are protein, carbs, fat and calories. The user interface 505 further can include one or more nutrient amounts for an amount per serving 513, including in this example, the same data as the panel 110, i.e., calories, fat, carbohydrates, and protein. The amount per serving 513 initially can display quantities corresponding to a single serving size of the recipe 106.

Also, as described regarding FIG. 1, the user interface 505 also can include a container volume scale 120, labeled “Total Volume,” which can be used to display the target container volume 120, expressed as a range of maximum and minimum target container volumes 150 and 154, respectively, which can be accommodated by the container 130. As shown in FIG. 1, the scale 104 detects the particular container 130 based on, for example, a container weight measurement. The container 130 can then be displayed on the user interface 505, such as, for example, the depiction of the container 130 based on the weight detection compared to the weight without the lid 324 data as part of the container data 308. The system 500 can then process the target volume range 155. FIG. 5A also includes an expanded view of the container volume scale 120 to show the details of the following components: maximum and minimum target container volumes 150 and 154, respectively, the container volume range 155 and the recipe volume 152. For example, the container volume range 155 can be a maximum target volume 150 of 16 ounces to a minimum target volume 154 of 4 ounces. The target range of volumes 155 can be based on the capacity of the container related to efficient and accurate combining or blending of ingredients or other factors, as also described regarding FIG. 1 above. The system 500 can then process the current recipe volume 152 for the recipe 106. The current recipe volume 152 can be generated based on a variety of approaches, such as, for example, based on a predetermined volume accompanying the recipe 106 as written. In another example, the current recipe volume 152 can be generated based on nutrient amounts of the ingredients (including volume and/or weight measurement) provided as predetermined in the written recipe 106 or as adjusted prior to executing the recipe 106, including on an individual basis or as a function of scaling of the recipe. Further options for the recipe volume 152 include applying the default predetermined volume or ingredient volumes based on a default single serving size for the recipe 106 (for example, as shown in FIG. 6A as 10 fluid ounces), or the serving size shown on the servings button 126 (in this FIG. 5A, 1.5 serving or 15 ounces). The servings button 126 quantity can reflect a default quantity or a quantity as changed. For another example, the current recipe volume 152 can be calculated based on the maximum number of servings which can be accommodated by the container 130 even if the maximum number is greater than the serving size shown on button 126 or received based on the recipe data 304, a selection or other input by a user (not shown). In this example, the current volume 152 shown on the servings button 126 is 15 ounces. In addition, the recipe 106 additional data on the user interface 505, such as the panel 110 of weights of individual ingredients and amount per serving 513, need not be adjusted at this point in the processing. This is because the ingredients are not yet being measured on the scale 104 such that a weight measurement can be obtained in order to produce nutritional data for the recipe 106, the panel 110 and the amount per serving 513.

FIG. 5B is another illustrative example of a system 500 that shows a user interface 505 of the client-computing device 202, such as a tablet, which can present options for adjusting the serving data for the recipe 106. The “Hint of Mint Smoothie” recipe 106 again is shown for illustration purposes. In this example, the user places a new container 132 on a blender 148 with a scale incorporated into the blender 148 (not shown). The scale detects the particular container 132 based on, for example, a container weight measurement. The container can then be displayed on the user interface 505, shown as container 132. The system 500 also can process the recipe volumes 152 which can be accommodated by the new container 132, including a maximum target container volume 150 and a minimum target container volume 154, for potential adjustment of the recipe volume 152 (such as, from a first recipe volume to a second recipe volume or new recipe volume). The system 500 also processes the current volume 152 for the recipe 106. The serving size (or recipe serving size) shown on the servings button 126 (in this case, 3 servings for a total volume 594 of 30 ounces) can be compared to the maximum target container volume 150 of 56 ounces, and/or the minimum target container volume of 16 ounces. In this example, the total volume 594 shown is 30 ounces. The nutritional panel 110 later can be updated to display the accumulating nutrient amounts based on the weight measurement of the ingredients as measured during execution of the recipe 106. The user interface 505 further can include an amount per serving 513. The amount per serving 513 can display quantities for nutrient amounts corresponding to a single serving of the recipe 106 or updated quantities based on changes to the nutrient amounts that impact the amount per serving 513.

FIGS. 5C-5D is an illustrative example of a system 500 that shows two versions of portions of the user interface 505 of the client-computing device 102, such as a tablet, usable to show a servings button adjustment panel 127. The serving button adjustment panel 127 can be activated by the system 500 receiving a selection of the serving button 126 based on the user interface 505. Upon activation, the serving button adjustment panel 127 can be displayed to show additional data entry and/or selection options for a user to enter a desired recipe measurement, including a desired recipe number of servings or a desired recipe servings size. A user (not shown) can then select or enter data to change one or more nutrient amounts (for example, as shown in user interface 505, a serving number 581 shown as 3, or a calorie 590 quantity). The desired recipe number of servings or servings size also can be referred to as the desired recipe number of servings or serving size measurements as selected by a user and received on the user interface 505. The changes in the nutrient amounts then prompt changes in the recipe 106 nutrient amounts, including the recipe volume 152. The data entry and/or selection options are as follows: a servings field 580 and a serving size field 582 providing data in a column format. The serving size field 582 can include two options for selection or data entry of the desired recipe measurement. These options can be a toggle option, or a selection of data entry for either “by calories” 584 or “by volume” 586. These toggle options can also be referred to as the desired recipe serving size measurement being a nutrient amount, such as the measurement of the volume or the calories. Different data corresponds to each option 584 or 586. As further shown on the serving button adjustment panel 127, the servings field 580 presents data options for selection of a number of servings, which is then displayed in the servings button 126. In this example, a rotatable display of serving numbers shown as whole numbers and simple fractions are provided (in other examples, a wide range of quantities can be provided), and the selections shown are the current serving number 581 of 3 in FIG. 5C and of 2 in FIG. 5D. As a result of the change to the serving field 580, the serving button 126 changes to the data selected in the servings field 580, shown for example as 3 for the servings button 126 in FIG. 5C and as 2 for the servings button 126 in FIG. 5D. The changes can be referenced by a first number of servings followed by a second, new or another new number of servings, or a first serving size followed by a second, new or another new serving size. In addition, the container volume scale 120 for the container 132 is impacted by the change in the selection in the serving field 580. While the maximum target volume 150 of 56 ounces and the minimum target volume 144 of 16 ounces have not changed, the change in the serving field 580 prompts a change to the recipe volume 152. The serving button adjustment panel 127 also can include a data display of the “Total Volume” 594, calculated based on the serving number 126 selection multiplied by the serving size 582 volume 586 (in this case, 10 fluid ounces). As a result, the FIG. 5C example shows a total volume 594 based on a number of servings 3 as 30 fluid ounces. Further, the FIG. 5D example shows a total volume 594 based on the number of servings 2 as 20 fluid ounces. The serving button 126 also can maintain a basic listing of the serving size 582, volume 586, and calories 584, regardless of changes to the number of servings. Similar to FIG. 5C, in FIG. 5D, the change to a serving number of 2 is shown in the serving field 580.

In addition, the container 132 and the container volume scale 120 are impacted by the change in the selection in the serving field 580. While the maximum target container volume 150 of 56 ounces and the minimum target container volume 154 of 16 ounces have not changed, the change in the serving field 580 prompts a change to the volume 152 to 30 fluid ounces used for the current serving size 580 of 3 of the recipe 106. In addition, in FIG. 5D, the container volume scale 120 is impacted by the change in the selection in the serving field 580. While the maximum target container volume 150 of 56 ounces and the minimum target volume 154 of 16 ounces have not changed, the change in the serving field 580 prompted a change to the current volume 152 to 20 fluid ounces. In addition, these data entry options can change the container volume scale 120 on an approximately real-time basis so that the user is supported to select from a variety of general containers 130 (shown in FIG. 5A) and 132 (shown in FIGS. 5B-5D with additional containers or categories of containers, not shown) and receive precise target container volume range 155 feedback. The feedback can include a target container volume range 155 within which the number of servings available for the recipe 106 can be determined. As the serving button adjustment panel 127 receives changes in input, the data shown on the container volume scale 120 can change and enable the user to determine options for the number of servings of the recipe 106 which can be accommodated within the target container volume range 155 of the container 132. Upon completing data entry of the desired recipe measurement, a location outside the panel 127 on the user interface 505 can be tapped to close the serving button adjustment panel 127 with the current setting for the numbers of servings on the servings button 126 for the recipe 106 and for the serving size 582 quantity. In addition, the other nutrient amounts can be changed for the recipe 106 as well. For another alternative, a reset button 596 can be activated. The reset button can return the nutrient amounts, including the number of servings and the serving size to their default settings, i.e., the settings for the recipe 106 as written, or another predetermined setting.

As further shown on the serving button adjustment panel 127 of FIGS. 5C and 5D, the serving size field 582 presents additional data options as the toggle options by calories 584 or by volume 586. In this example, a rotatable display of quantities 590 representing calories 584 is shown in FIG. 5C, as well as quantity change buttons 588 and 592 in preset increments of positive and negative 50 calories, respectively. When the serving size field 582 is toggled to the by volume 586 option, the volume that is displayed can correspond to the last selected calorie option 584. The by calories quantity shown in FIGS. 5C and 5D is 203 calories.

FIG. 5E is an illustrative example of a system 500 that shows a user interface 505 of the client-computing device 102, such as a tablet, which can present options for adjusting the serving data for the recipe 106 using the illustrative “Hint of Mint Smoothie” recipe 106 shown previously in FIGS. 5A and 5B. FIG. 5E shows the user interface 505 with a different container 134 and the resulting changes to the container volume scale 120 quantities for 150, 152 and 154. The recipe volume 152 is changed in this example because the container 134 maximum target container volume 150 is less than the default serving size of the recipe 106. The system 500 processes the current volume 152 for the recipe 106 based on the number of servings shown on the servings button 126 (in this case, ½ servings) for a volume 152 of 5 ounces. The recipe volume 152 is between the maximum and minimum target container volumes 150 and 154, respectively, which can be accommodated by the container 134 of 7 ounces and 2 ounces, respectively. Where the number of servings of the recipe 106, as shown on the servings button 126, results in a recipe volume 152 that is greater than the maximum target volume 150, the smart app 202 can provide an adjustment on the container volume scale 120 showing that the recipe volume 152 is higher than the maximum target volume 150. The smart app 202 also can provide a notification on the user interface 505, prompting an adjustment of the selection of a new container by the user of the recipe volume 152. The smart app 202 further can adjust the recipe volume 152 to within the container volume range 155.

FIG. 5F is an illustrative example of a system 500 that shows a user interface 505 of the client-computing device 102 and the same display components and options as in FIG. 5E. In this example, the user replaces the FIG. 5E container with the larger container of FIG. 1, or container 130. A user can do this, for example, to accommodate the recipe volume 152 single serving portion that is too small for the FIG. 5E container 134. FIG. 5F shows the user interface 505, changes to the container volume scale 120, and quantities for 150, 152 and 154. The system 500 then processes the current volume 152 for the recipe 106, the serving size shown on the servings button 126 (in this case, the prior ½ servings or 4 ounces is still shown), the maximum and minimum target container volumes 150 and 154, respectively, which can be accommodated by the container 130 of 16 ounces and 4 ounces, respectively. Where the number of servings of the recipe 106 is less than the minimum target volume 154, the smart app 202 can provide either an adjustment or notifications similar to the processing when the recipe volume 152 is greater than the maximum target container volume 150. In other examples, the smart app 202 can provide a notification that the volume 152 for the recipe 106 is close to either the maximum or minimum target volumes 150 or 154, respectively, and suggest that the user enter a different number of servings for more efficient blending. Therefore, in another example, the maximum and minimum target container volumes 150 and 154, respectively, also can be used for approximate guidelines, rather than absolute quantities. In another example, adjustments can be made to the recipe 106 or the container 130 when the recipe volume 152 approximates either of the maximum and minimum target container volume 150 and 154, respectively, or adjustments can be made depending upon how close the recipe volume 152 is to either target container volume 150 or 154.

FIG. 5G is an illustrative example of a system 500 that shows a user interface 505 of the client-computing device 102, with a return to the original single number of servings, shown on the servings button 126, of the recipe 106. One can postulate with the higher maximum target container volume 150 for container 130, the user changed the number of servings to 1. Similarly as in FIGS. 5E and 5F, the volume 152 is changed to reflect the number of servings on button 126.

FIG. 6A is an illustrative example of a system 600 that shows a sample user interface 605 of a client-computing device 102, such as a tablet (not shown), which can present information about the recipe 106 and its ingredients. The “Hint of Mint Smoothie” recipe 106 is shown for illustration purposes. The user interface 605 includes a nutritional panel 610, similar to the nutritional panel shown in FIG. 1. The nutritional panel 610 of this FIG. 6A includes the data in column form, with nutrient amounts for protein 616, carbohydrates 617 (shown as “Carbs”), fat 618 and the number of calories 619. In additional examples, a range of nutrient amounts can be provided. The quantity for each of the categories shows 0 because in this example, combining the ingredients for the recipe 106 has not yet occurred. The user interface 605 also shows a servings button 126, with the serving number shown as 1 serving. Upon container 130 selection and recipe execution, the nutritional panel 610, further, can include the nutrient amounts for the recipe 106 for each ingredient as it is added to the container 130 and measured on the scale 104, and/or an aggregation of the nutritional data for the recipe 106 totals of the nutrient amounts 616-619. The user interface 605 also can include a recipe column 107 including a series of recipe ingredient blocks 612 and action blocks 640. The recipe ingredient blocks 612 can show a listing of each ingredient and can also show ingredient data, including for example, the weight or volume of the ingredient, as well as additional instructions. For example, in FIG. 6A, the following ingredients are listed in the recipe ingredient blocks 612: spinach 650 with a weight of 21.7 g or about 0.75 cup and with a recommendation for “fresh spinach leaves,” green grapes 660 with a weight of 38.3 g or about 4 T (or tablespoons) and coconut water 670 with a volume of 1.22 fluid ounces or about 2.5 T (or tablespoons). In this example, selected ingredients from the “Hint Of Mint Smoothie” recipe 106 for illustration purposes are shown, with the full ingredient list being available for presentation as additional blocks 612, which can be presented (not shown) in the recipe column 607. The display can also provide a dynamic movement of its contents, such as scrolling through ingredients for the recipe 106 where providing ingredient information for a number of recipe ingredients lends itself to a scrolling or movement function to optimize the data provided per ingredient. (The full list of ingredients for the “Hint of Mint Smoothie” recipe 106 is shown in FIG. 6B, in the list of ingredients 621.) The user interface 605 also shows action blocks 640, including a blend action block 642 and a serve action block 644. The action blocks 640 reflect the names of actions shown in FIG. 3A, the action data 310. Additional instructions can be shown with each. For example, the blend action block 642 provides a description of the blend time of 45 seconds and an instruction for blending of “until smooth.” The serve action block 644 provides a quantity for single serving portion of 10 fluid ounces. In the example shown in FIG. 6A, an amount per serving 513 is shown as calories 135, fat 1 g, carbs 34 g and protein 2 g. The user interface 605 also shows additional narrative information about the Hint of Mint Smoothie recipe 106 (shown as, for example, “Times made,” “Categories,” “Warning” information, or similar), and drop down sections for “Ingredients” 620 and individual ingredients 621 for the section 620.

FIG. 6B is a further illustrative example of a system 600 that shows on the same user interface 605, an expansion of the “ingredients” 620 section to include a list of the ingredients 621 for the recipe 106. The nutrient amount shown for each ingredient in the recipe 106 is the weight in grams, which in this example, equates to the weight for 1 serving as shown on the servings button 126. In alternative examples, the quantity of each ingredient can be shown as volume or other measurement. The user interface 605 also shows “Nutrition Info” 622 and an expansion of the “Nutritional Info” 622 section to include nutrient amounts (labeled as “Nutrition Facts”) 624. The Nutrition Facts 624 generally is shown with a serving size of 1 (and for this recipe 106, the single serving equates to a weight of 282 g).

FIG. 6C is another illustrative example of a system 600 that shows the servings button 126 being activated. Upon activation, the serving button 126 triggers the display of the serving button adjustment panel 127, including listings of the current number 3 of servings 581 in the servings 580 column and the calories 590 of 135 in the serving size 582 by calories 584 fields. The user interface 605 also shows additional narrative information about the “Hint of Mint Smoothie” recipe 106 (shown as, for example, “Times made,” “Categories,” “Warning” information, or similar), and the drop down sections for “Ingredients,” “Nutrition Info” and “Cookware.” The Cookware section can also provide recommendations for containers.

FIG. 6C is a further illustrative example of a system 600. It shows that, based on the selection of the quantity 581 of 3 in the servings 580 field, the servings button 126 has been changed to increase the serving number 581 from 1 (as previously shown in FIG. 6B) to 3. Further, the by calories 584 field quantity 590 shows 135 or the equivalent of the single serving number of calories or a single serving volume of 10 fluid ounces. As a result, the volume 152 for the recipe 106 stands at 10 fluid ounces, and the total volume 594, therefore, is the number of servings 3 multiplied by the fluid ounces per servings of 10 fluid ounces, or 30 fl. oz. (or fluid ounces).

The system 100 supports scaling a recipe with precision based on nutrient amounts of the recipe in order to align the recipe with the maximum and/or minimum target container volumes 150 and 154, respectively. Examples are scaling based on specific quantities for a servings size measured by volume or by calories (or another nutrient amount). Alternatively, or in addition, recipes can be further scaled by changing the number of servings. In other examples, scaling can be based on precise nutrient amount quantities to support optimizing recipes for specific nutritional goals and/or to align recipes with particular containers or categories of containers.

### CONCLUSION

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense,

What is claimed is:

1. A system comprising:
a scale;
a computing device having at least one processor, at least one user interface and a memory; and
the memory including computer-executable instructions that, when executed by the at least one processor, cause the at least one processor to:
receive a recipe, the recipe indicating at least two ingredients, a first number of servings and a first recipe volume associated with the first number of servings;
receive container data for a plurality of containers, the container data including a container weight and a maximum target container volume for one or more of the plurality of containers, a first container of the plurality of containers having a first container weight and a maximum target first container volume;
receive, from the scale, a container weight measurement;
identify, based at least in part on the container weight measurement, the first container;
identify the maximum target first container volume associated with the first container; and
render on the user interface, a first display indicating data associated with the maximum target first container volume and the first recipe volume.

2. The system of claim 1, the container data further including a minimum target container volume for one or more of the plurality of containers, the first container further having a minimum target first container volume, wherein the computer-executable instructions further cause the at least one processor to: render, on the user interface, the first display indicating data associated with the minimum target first container volume.

3. The system of claim 2, at least one of the maximum target container volume or the minimum target container volume being based, at least in part, on at least one of a container geometry or a blade associated with the container, and the first display further indicating data associated with the first recipe volume compared to at least one of the maximum target container volume or the minimum target container volume.

4. The system of claim 1, a second container of the plurality of containers having a second container weight and a maximum target second container volume, and wherein the computer-executable instructions further cause the at least one processor to:
receive, from the scale, a new container weight measurement;
identify, based at least in part on the new container weight measurement, the second container;
identify the maximum target second container volume associated with the second container; and
render on the user interface, the first display indicating data associated with the maximum target second container volume and the first recipe volume.

5. The system of claim 4, the second container further having a minimum target second container volume, wherein the computer-executable instructions further cause the at least one processor to: render, on the user interface, the first display indicating data associated the minimum target second container volume.

6. The system of claim 2, wherein the computer-executable instructions further cause the at least one processor to:
receive, from the user interface, a desired recipe measurement;
generate a second recipe volume based, at least in part, on the desired recipe measurement;
determine that the second recipe volume is one of equal to the maximum target second container volume or below the maximum target second container volume, and the second recipe volume is one of equal to the minimum target second container volume or above than the minimum target second container volume; and
upon determining that the second recipe volume is one of equal to the maximum target second container volume or below the maximum target second container volume, and the second recipe volume is one of equal to the minimum target second container volume or above than the minimum target second container volume, render on the user interface, the first display indicating data associated with the second recipe volume compared to at least one of the maximum target container volume or the minimum target container volume.

7. The system of claim 6, wherein the computer-executable instructions further cause the at least one processor to:
determine that the second recipe volume is at least one of one of above the maximum target second container volume or lower than the minimum target second container volume; and
upon determining that the second recipe volume is at least one of above the maximum target second container volume or lower than the minimum target second container volume, render on the user interface, a notification indicating that the desired recipe measurement is at least one of above the maximum target second container volume or lower than the minimum target second container volume.

8. The system of claim 6, the desired recipe measurement being one of a number of servings, a serving size, or one or more of a plurality of nutrient amounts received as a data entry on the user interface, and each of the nutrient amounts being a measurement of one of a weight, a volume, a protein, a fat, carbohydrates or calories.

9. The system of claim 8, the serving size being set based on at least one of the volume or the calories, and wherein the computer-executable instructions further cause the at least one processor to:
determine that the desired recipe measurement of the serving size is based on the calories; and
upon determining that the desired recipe measurement of the serving size is based on the calories:
generate a new serving size based on the calories; and
render, on the user interface, a second display indicating data associated with the new serving size.

10. The system of claim 8, wherein the computer-executable instructions further cause the at least one processor to:
determine that the desired recipe measurement of serving size is based on the volume;
upon determining that the desired recipe measurement of serving size is based on the volume, render, on the user interface, a second display indicating data associated with the serving size, whereby the serving size is not changed based on the desired recipe measurement of serving size.

11. The system of claim 9, wherein the computer-executable instructions further cause the at least one processor to: render on the user interface, the second display indicating data associated with one of the first recipe volume or the second recipe volume.

12. The system of claim 9, the first display and the second display being different portions of a single display, separate displays being activated independent of one another, or the second display being activated by a component of the first display.

13. The system of claim 5, the first display indicates data associated with at least one or more of the maximum target first container volume, the minimum target first container volume, the first recipe volume, the maximum target second container volume, the minimum target second container volume or the second recipe volume, and the first display includes one or more of text, alphanumeric characters, numeral characters, graphics, depictions, scales, charts, visual indications, audio indications, video indications, or photographic indications.

14. A system comprising:
a scale;
a computing device having at least one processor, at least one user interface and a memory; and
the memory including computer-executable instructions that, when executed by the at least one processor, cause the at least one processor to:
receive a recipe, the recipe indicating at least two ingredients and a first number of servings;
determine a first recipe volume based, at least in part, on the ingredients and the first number of servings;
receive container data for a plurality of containers, the container data including a container weight and a maximum target container volume for one or more of the plurality of containers, a first container of the plurality of containers having a first container weight and a maximum target first container volume;
receive, from the scale, a container weight measurement;
identify, based at least in part on the container weight measurement, the first container;
identify the maximum target first container volume for the first container;
render on the user interface, a first display indicating data associated with the maximum target first container volume;
determine that the first recipe volume is greater than the maximum target first container volume; and
upon determining that the first recipe volume is greater than the maximum target first container volume:
generate a second recipe volume based, at least in part, on changing the first number of servings in order to configure the second recipe volume to be at least one of less than the maximum target first container volume or equal to the maximum target first container volume; and
render on the user interface, a first display indicating data associated with the second recipe volume.

15. The system of claim 14, the container data further including a minimum target container volume, the first container further having a minimum target first container volume, wherein the computer-executable instructions further cause the at least one processor to:
determine that the first recipe volume is less than the minimum target first container volume; and
upon determining that the first recipe volume is less than the minimum target first container volume:
determine a second recipe volume based, at least in part, on changing the first number of servings in order to configure the second recipe volume to be greater than the minimum target first container volume and one of less than the maximum target first container volume or equal to the maximum target first container volume; and
render on the user interface, an update to the first display indicating data associated with the second recipe volume.

16. A system comprising:
a scale;
a computing device having at least one processor, at least one user interface and a memory; and
the memory including computer-executable instructions that, when executed by the at least one processor, cause the at least one processor to:
receive a recipe, the recipe indicating at least two ingredients, a first number of servings and a first recipe volume associated with the first number of servings;
receive container data for a plurality of containers, the container data including a container weight and a minimum target container volume for one or more of the plurality of containers, a first container of the plurality of containers having a first container weight and a minimum target first container volume;
receive, from the scale, a container weight measurement;
identify, based at least in part on the container weight measurement, the first container;
identify the minimum target first container volume associated with the first container; and
render on the user interface, a first display indicating data associated with the minimum target first container volume and the first recipe volume.

17. The system of claim 1, the container data further including a maximum target container volume for one or more of the plurality of containers, the first container further having a maximum target first container volume, wherein the computer-executable instructions further cause the at least one processor to: render, on the user interface, the first display indicating data associated with the maximum target first container volume.

18. A method comprising:
receiving a recipe, the recipe indicating at least two ingredients, a first recipe number of servings and a first recipe volume associated with the first number of servings;
receiving container data for a plurality of containers, the container data including a container weight and a maximum target container volume for one or more of the plurality of containers, a first container of the plurality of containers having a first container weight and a maximum target first container volume;
receiving, from a scale, a container weight measurement;
identifying, based at least in part on the container weight measurement, the first container;
identifying the maximum target first container volume associated with the first container; and
rendering on the user interface, a first display indicating data associated with the maximum target first container volume and the first recipe volume.

19. The method as recited in claim 18, the container data further including a minimum target container volume for one or more of the plurality of containers, the first container further having a minimum target first container volume, further comprising: render, on the user interface, the first display indicating data associated with the minimum target first container volume.

20. The method as recited in claim 19, a second container of the plurality of containers having a second container weight and a maximum target second container volume, further comprising:
receiving, from the scale, a new container weight measurement;
identifying, based at least in part on the new container weight measurement, the second container;
identifying the maximum target second container volume associated with the second container; and
rendering on the user interface, the first display indicating data associated with the maximum target second container volume and the first recipe volume.

21. The method as recited in claim 18, further comprising:
determining that the first recipe volume is greater than the maximum target first container volume; and
upon determining that the first recipe volume is greater than the maximum target first container volume:
generating a second recipe volume based, at least in part, on changing the first number of servings in order to configure the second recipe volume to be at least one of less than the maximum target first container volume or equal to the maximum target first container volume; and
rendering on the user interface, a first display indicating data associated with the second recipe volume.
